(19) United States
(12) Patent Application Publication
(10) Pub. No.: US 2009/0025499 A1
(43) Pub. Date: Jan. 29, 2009

(54) Drive unit

(75) Inventor: Naoto SHIGA, Saitama-shi (JP)

Correspondence Address: ROTHWELL, FIGG, ERNST & MANBECK, P.C., 1425 K STREET, N.W., SUITE 800, WASHINGTON, DC, 20005, US

(73) Assignee: TAMRON CO., LTD., Saitama-shi, (JP)

(21) Appl. No.: 12/031,828

(22) Filed: Feb. 15, 2008

(30) Foreign Application Priority Data
Feb. 15, 2007 (JP) JP2007-034666

(51) Int. Cl. F16H 25/24

(52) U.S. Cl. 74/424.71

(57) ABSTRACT

Object of the present invention is to provide a miniaturized drive unit which has the function of measuring the slide distance of a driven object. The drive unit 1 has the rotary encoder 5. The rotary encoder 5 comprises the rotary scale 51 and the magnetic sensor 52. The rotary scale 51 is fixed on the one-end side of the lead screw 21, and the magnetic sensor 52 is provided opposite to the rotary scale 51. The rotary scale 51 rotates according to the sliding of a lens group holding frame. With rotating of the rotary scale, the magnetic sensor 52 detects a magnetic change caused by the rotary scale 51, and the magnetic sensor 52 converts the magnetic change into the signal to transmit the signal to a control section. The control section calculates the slide distance of the lens group holding frame from the signal output from the magnetic sensor 52 and takes the value for the slide distance of the lens group.

### BACKGROUND OF THE INVENTION

1. Field of the Invention

The present invention relates to a drive unit, for example a drive unit to slide a lens group of an imaging device.

2. Description of the Related Art

Hitherto, there has been generally used a method of moving a lens group for an optical axis in imaging devices such as digital cameras. The lens group is generally supported by a lens group holding frame. And the lens group holding frame is arranged so as to be slid along the optical axis by using a guide portion provided in a housing.

Also, an imaging device is provided with a drive unit to drive a lens group holding frame (see U.S. Pat. No. 6,940,209, for example). For example, a drive unit provided with a lead screw, a driving nut, a holding means and a connecting portion is known as the kind of drive unit. A driving nut is provided with a nut screwed onto the lead screw and four piezo-elements provided at a peripheral portion of the nut. The holding means is composed to fit the lead screw to which the driving nut is attached, and to support the lead screw to be able to rotate. The connecting portion is protruding from the piezo-elements to connect to the lens group holding frame.

In order to drive the lens group holding frame by using the driving unit, first, a driving power and a control signal are supplied to the piezo-elements. As a result, the piezo-elements vibrate and the lead screw rotates clockwise or counterclockwise. The rotation of the lead screw moves the nut on the lead screw. As a result of the movement of the nut, the connecting portion moves. Therefore, the lens group holding frame is to be slid.

On the other hand, an imaging device is required to detect the position of a lens group with good accuracy focusing by an auto-focus function. For this reason, an imaging device is provided with a measuring device for measuring the slide distance of a lens group (refer to Japanese Patent Laid-Open No. 2006-119570, for example).

The measuring device is provided with an encode plate (encoder scale), a photoelectric sensor (detection means) and a lens position control section. A measuring method of the slide distance of a lens group by use of the measuring device will be described below. When the lens group holding frame moves, the photoelectric sensor radiates infrared light on an encoder scale from a light projecting portion. The infrared light radiated on the encoder scale is reflected and received by a light receiving portion of the photoelectric sensor. On the basis of a change of the reflected infrared light, the photoelectric sensor outputs a signal to the lens position control section. The lens position control section calculates the slide distance of the lens group holding frame from the signal output from the photoelectric sensor and takes the value for the slide distance of the lens group.

Therefore, when the measuring device described in Japanese Patent Laid-Open No. 2006-119570 is provided at the above-described drive unit, it is conceivable that the encoder scale is provided at the driving nut and the connecting part and that the detection means is provided at the holding means.

[Patent document 1] U.S. Pat. No. 6,940,209
[Patent document 2] Japanese Patent Laid-Open No. 2006-119570

However, a drive unit with an encoder scale provided at the connecting part, it is necessary to substantially make the holding means large in order to fit the encoder scale in the holding means. Therefore, there is a problem of whole size of the drive unit is to be large.

The present invention has been made in view of the conventional problem, and the purpose of the present invention is to provide a drive unit which can be miniaturized even having a function of measuring slide distance of a driven object.

### SUMMARY OF THE INVENTION

After extensive investigation, the present inventors have employed the following drive unit to solve the above problem.

A drive unit of the present invention is the drive unit to slide a driven object, which comprising:

a lead screw;
a driving nut screwed onto a central part of the lead screw;
a connecting part protruding from the driving nut for being connected to the driven object;
a rotary scale inserted onto a one-end side of the lead screw and fixed directly or indirectly;
a holding means containing the lead screw supported to be able to rotate, to which the rotary scale and the driving nut are attached; and
a detection means provided at the holding means,

wherein the driving nut rotates the lead screw clockwise or counterclockwise by a driving power and a control signal from outside, thereby moves on the lead screw;

the connecting part makes the driven object slide by utilizing the movement of the driving unit;

the rotary scale rotates as a result of the rotation of the lead screw; and

the detection means transmits output signal measuring the slide distance of the driven object by using the rotary scale rotating together with lead screw to outside.

As described above, the drive unit of the present invention enables miniaturization of the holding means by providing a rotary scale on a one-end side of the lead screw when compared to a drive unit with an encoder scale provided at a driving nut or a connecting part.

The drive unit according to the present invention, wherein the driving nut is provided with a nut screwed onto a central part of the lead screw and a piezo-element provided at a peripheral portion of the nut, the connecting part being connected to the piezo-element; a driving power and a control signal are supplied to the piezo-element to move the nut on the lead screw by rotating the lead screw clockwise or counterclockwise; and the connecting part is provided to slide the driven object by utilizing the movement of the nut.

As described above, the drive unit of the present invention enables miniaturization of the holding means by providing a rotary scale at a one-end side of the lead screw when compared to a drive unit with an encoder scale provided at a connecting part.

The drive unit according to the present invention is characterized in that, a concave portion is provided at both end surfaces of the lead screw, the holding means having a pair of supporting means for supporting to be able to rotate on both end sides of the lead screw; and each of the pair of supporting means comprises a holder having a concave portion opposed to the concave portion of the lead screw and a bearing ball sandwiched and held between the concaved portion of the holder and the concaved portion of the lead screw.

As described above, the drive unit of the present invention enables to rotate the lead screw smoothly with reduced number of components for the drive unit.

The drive unit according to the present invention is characterized in that, the holding means has a pair of supporting means for supporting to be able to rotate on both end sides of the lead screw, each of the pair of supporting means comprising a lead screw holder, a bearing ball and a baring ball holder, each of which is arranged close to the lead screw in order along the axis of the lead screw; the lead screw holder has a first concave portion holding an end portion of the lead screw and a second concave portion provided at a side opposite to the first concave portion, and the lead screw holder rotates as a result of the rotating of the lead screw; the bearing ball holder has a third concave portion opposed to the second concave portion of the lead screw holder; and the bearing ball is sandwiched and held between the second concave portion of the lead screw holder and the third concave portion of the bearing ball holder.

As described above, the drive unit of the present invention enables to freely set the size of the concave portion to sandwich and hold the bearing ball without consideration on the diameter of the lead screw. Therefore, the drive unit of the present invention enables to use a bearing ball having larger diameter against to a drive unit in which bearing balls are sandwiched and held between a lead screw and a holder.

Also, the drive unit according to the present invention is characterized in that, the lead screw holder of one of the pair of supporting means is such that a peripheral portion of a first concave portion side is formed in the shape of an annulus as a center of the axis of lead screw and the rotary scale is to be fit onto the peripheral portion.

As described above, the drive unit of the present invention makes it possible to install the rotary scale and the lead screw holder to the lead screw in construction of the drive unit, or detach them in separation of the lead screw as one unit.

### ADVANTAGES OF THE INVENTION

In the drive unit of the present invention, the rotary scale is provided at a one-end side of the lead screw. With such a construction, the drive unit of the present invention, it is possible to make the size of the holding means smaller than a drive unit in which the encoder is provided at the driving nut and the connecting part. Therefore, the drive unit of the present invention can be miniaturized even if it has the function of measuring the slide distance of a driven object.

In the drive unit of the present invention, the driving nut is provided with the nut and the piezo-element. Also in such case, the drive unit of the present invention enables miniaturization of the holding means when compared to a drive unit in which an encoder is provided at a driving nut or a connecting part. Therefore, the drive unit of the present invention can be miniaturized even if the drive unit having the function of measuring slide distance of a driven object.

In the drive unit of the present invention, each of a pair of supporting means is provided with one holder and one bearing. With such a construction, the drive unit of the present invention enables to rotate the lead screw smoothly with reduced number of components for the drive unit. Therefore, the drive unit of the present invention enables to slide a driven object smoothly with reduced cost.

In the drive unit of the present invention, each of a pair of supporting means is provided with two holders and one bearing ball. With such a construction, the drive unit of the present invention enables to freely set the size of the concave portion to sandwich and hold the bearing ball without consideration on the diameter of the lead screw. Therefore, the drive unit of the present invention enables to use a bearing ball having larger diameter against to a drive unit in which bearing balls are sandwiched and held between a lead screw and a holder with a minimum cost.

Furthermore, in the drive unit of the present invention, the rotary scale is to be fit onto the lead screw holder. With such a construction, the drive unit of the present invention enables to install the rotary scale and the lead screw holder to the lead screw in construction of the drive unit, or detach them in separation of the lead screw as one unit. Therefore, the drive unit of the present invention enables to improve the efficiency of assembling or disassembling the drive unit.

### BRIEF DESCRIPTION OF THE DRAWINGS

FIG. 1 is a schematic view showing a cellular phone in the first embodiment of the present invention;

FIG. 2 is a schematic side view of a drive unit in the embodiment;

FIG. 3 is a schematic longitudinal sectional view of the drive unit of the embodiment;

FIG. 4 is an A-A sectional view of FIG. 2;

FIG. 5 is a schematic side view of a drive unit in the second embodiment of the present invention; and

FIG. 6 is a schematic longitudinal sectional view of the drive unit of the embodiment.

### DETAILED DESCRIPTION OF THE PREFERRED EMBODIMENTS

Embodiments of the present invention will be described below with reference of the drawings.

### First Embodiment

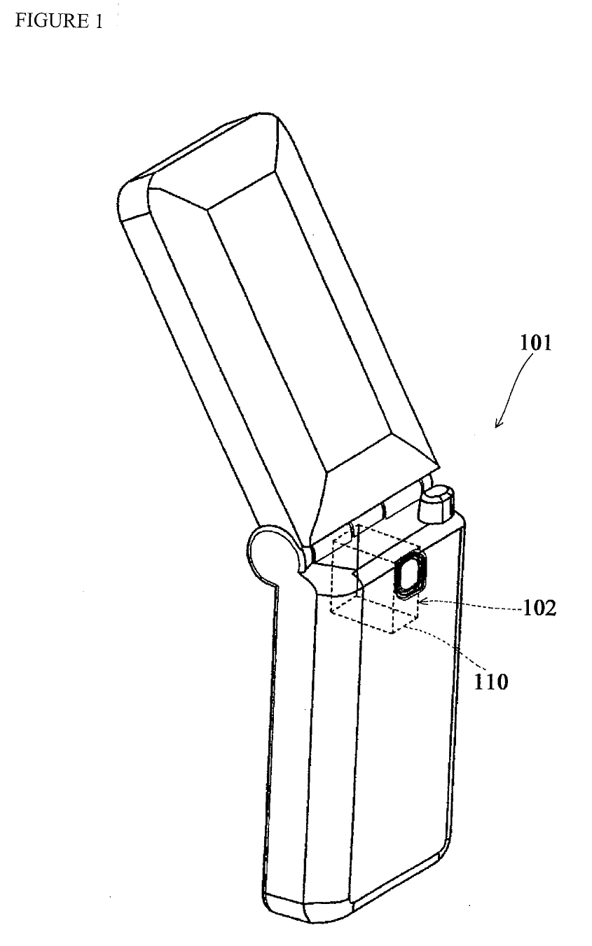

FIG. 1 is a schematic view showing a cellular phone 101 in the first embodiment of the present invention. The cellular phone 101 has the function of the camera and is provided with a camera module 102. The camera module 102 is provided with a case 101 formed in box shape, a lens unit disposed within the case 110, and a charged coupled device (CCD). And the camera module 102 is composed to image the reflected light from a photographic subject by use of the charged coupled device according to operations of the user, convert the formed image into an electrical signal, and output the electrical signal to an A/D converter and the like.

The lens unit is provided with two lens group holding frames and a lens driving device, which are not shown. Two of the lens group holding frames are arranged along the optical axis, and each of the lens group holding frames is composed such that a lens group is held their inside. The lens driving device is to drive each of the lens group holding frames independently. The lens driving device is provided with two guide poles and two drive units, which are not shown. Each of the guide poles is arranged so as to support the lens group holding frame movable for the optical axis direction.

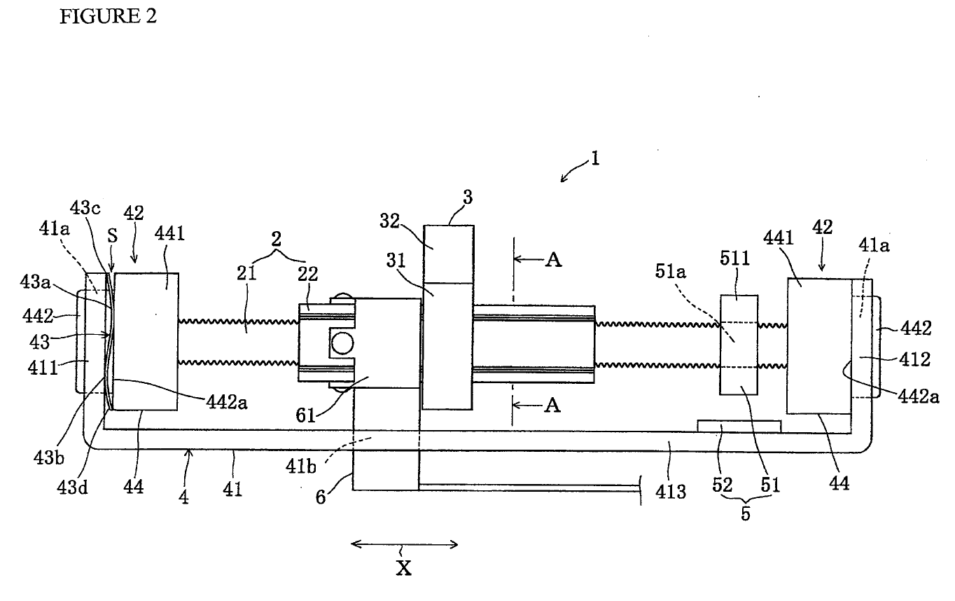

Each of the driving units drives the lens group holding frame. FIG. 2 is a schematic side view of a drive unit 1. The drive unit 1 is provided with a piezo-motor 2, a connecting part 3, holding means 4, and a rotary encoder 5.

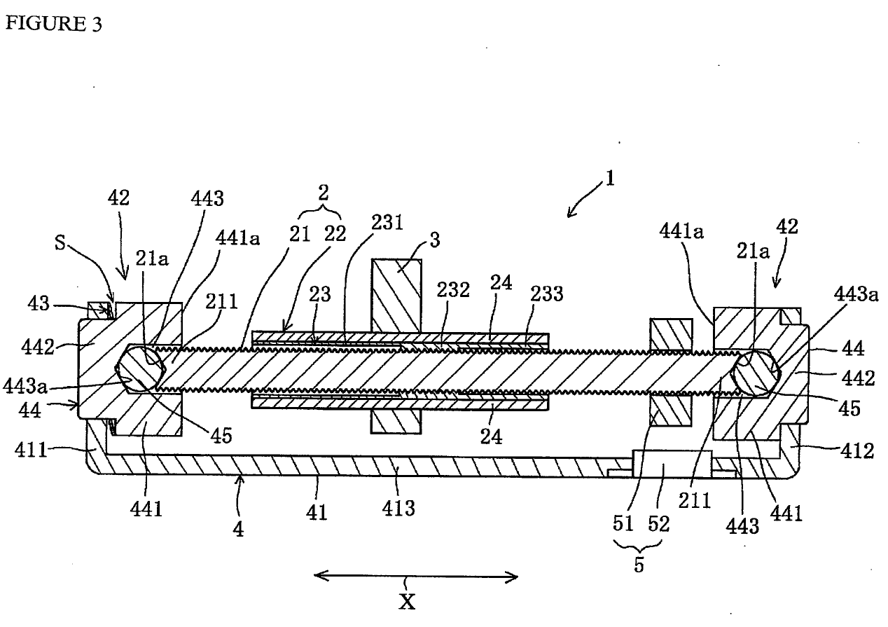

The piezo-motor 2 is provided with a lead screw 21 and a driving nut 22. The lead screw 21 is arranged for the optical axis direction X. And as shown in FIG. 3, a concave portion 21a is provided at both end surfaces of the lead screw 21. The concave portion 21a is formed in such a method that the cross sectional shape thereof shows a wedge-shaped dent for the optical axis direction X.

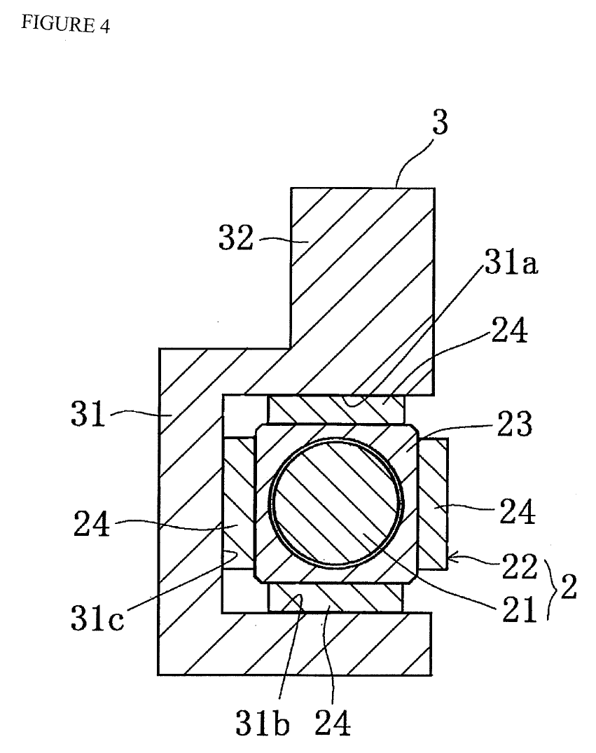

As shown in FIG. 4, the driving nut 22 is provided with a nut 23 and four piezo-elements 24. As shown in FIG. 3, the nut 23 is screwed onto a center part of the lead screw 21. To explain the definitely, the nut 23 is formed to be elongated for the optical axis direction X. A left half 231 of the nut 23 is to be loosely fit with the lead screw 21. In the right half of the nut 23, a left side portion 232 connecting to the left half 231 is screwed and fit into the lead screw 21. A remainder 233 of the right side portion touches to the lead screw 21.

As shown in FIG. 4, the four piezo-elements 24 are provided at the peripheral portion of the nut 23. And as shown in FIG. 2, a terminal portion 61 of a flexible printed wiring board 6 on one side thereof is connected to the four piezo-elements 24. The flexible printed wiring board 6 is intended for supplying a drive power supply and a control signal to each of the piezo-elements 24 and connected, on the other side thereof, to a power supply and a control section (not shown).

On the other hand, the connecting part 3 is a portion that moves the lens group holding frame by utilizing the driving force output from the piezo-motor 2. As shown in FIGS. 2 and 3, the connecting part 3 is protruding from the middle portion of the driving nut 22. And as shown in FIG. 4, the connecting part 3 is provided with a housing portion 31 and a connecting part 32.

The housing portion 31 is formed in the shape of the right-side opened square turned through 90 degrees to right as viewed from the rear side (the right side of FIG. 2). Within the housing portion 31, the piezo-motor 2 is housed and fixed. Definitely, each of three piezo-elements 24 is fixed with an adhesive to an upper inner wall surface 31a, a lower inner wall surface 31b and a left side inner wall surface 31c of the housing portion 31. Incidentally, it is not restrictive that all of the three piezo-elements 24 are fixed to the respective opposed inner wall surfaces as in the embodiment, but it is just required that at least one piezo-element 24 be fixed to an opposed inner surface wall.

The connecting part 32 is connected to an upper surface of the housing portion 31. The connecting part 32 is protruding, and its tip is connected to the lens group holding frame. Incidentally, the connecting part 32 may be formed so as to protrude from a bottom surface of the housing portion or may also be formed so as to protrude from a side surface.

On the other hand, as shown in FIG. 2, the holding means 4 is provided with a holding portion 41, a pair of supporting means 42, 42, and two plate springs 43.

The holding portion 41 is intended for housing the piezo-motor 2 and the rotary encoder 5. The holding portion 41 is formed in channel shape as viewed from the side. And a holder method 41a is formed in a middle portion of each of a front portion 411 and a rear portion 412 of the holding portion 41. A hole 41b through which the flexible printed wiring board 6 is inserted is provided at a bottom portion 413 of the holding portion 41.

The pair of supporting means 42, 42 is to support to be able to rotate in both end sides of the lead screw 21. As shown in FIGS. 2 and 3, each of the supporting means 42 is provided with a holder 44 and a bearing ball 45.

The holder 44 is composed of a holder main frame 441 and a mounting portion 442. The mounting portion 442 is mounted by being inserted into a holder mean 41a of the holding portion 41, and formed in square shape. The mounting portion 442 may be circular.

The holder main frame 441 is arranged within the holder portion 41 and is connected to an inner end surface 442a of the mounting portion 442 (see FIG. 2). The holder main frame 441 has vertical and lateral dimensions larger than the mounting portion 442 and is formed in square shape. And as shown in FIG. 3, the hole 443 is provided at an inner end surface 441a of the holder main frame 441. The hole 443 is formed parallel to the optical axis direction X. And an end portion 211 of the lead screw 21 is inserted into the hole 443 and arranged there. The holder main frame 441 may be circular.

A bottom portion 443a of the hole 443 is composing a concave portion related to the present invention. The concave portion 443s is formed so as to be opposed to the concave portion 21a of the lead screw 21. The concave portion 443a is formed in such a method that the cross sectional shape thereof shows a wedge-shaped dent in the optical axis direction X.

The bearing ball 45 is arranged at the hole 443 of the holder main frame 441 by being supported by the concave portion 443a of the holder main frame 441 and the concave portion 21a of the lead screw 21 in a sandwiched method.

As shown in FIG. 2, the two plate springs 43 are each arranged between two gaps in the shape of letter S that are formed between the front portion 411 of the holding portion 41 and the holder main frame 441 on the right and left sides of the mounting portion 442. The plate spring 43 is formed in the shape of an elongated letter S. And a curved portion 43a on the upper side of the plate spring 43 touch to the holder main frame 441, and a curved portion 43b on the lower side touch to the front portion 411 of the holding portion 41. In the state, a top end portion 43c of the plate spring 43 is fixed to the front portion 411 of the holding portion 41, and a bottom end portion 43d thereof is fixed to the holder main frame 441.

Next, a driving method of the lens group holding frame by use of the drive unit 1 will be described below. First, a drive power and a control signal are supplied from the power supply and the control section to each of the piezo-elements 24 via the flexible printed wiring board 6. With such a construction, each of the piezo-elements 24 vibrates and the lead screw 21 rotates clockwise or counterclockwise. The nut 23 moves on the lead screw 21 by the rotation of the lead screw 21. As a result of the movement, the connecting part 3 moves for the optical axis direction X and the lens group holding frame also slide along the guide pole in the optical axis direction X.

On the other hand, the rotary encoder 5 is used for measuring the slide distance of the lens group holding frame (lens group). The rotary encoder 5 is a magnetic type rotary encoder. And as shown in FIGS. 2 and 3, the rotary encoder 5 is composed of a rotary scale 51 and a magnetic sensor (detection means) 52.

The rotary scale 51 is formed in the shape of a ring. And the rotary scale 51 is provided at a one-end side of the lead screw 21 inward from the holder 44. The one-end side of the lead screw 21 is inserted into a center hole 51a (see FIG. 2) of the rotary scale 51, and in the state the rotary scale 51 is fixed directly to the lead screw 21. A prescribed magnetic pattern is circumferentially formed in a peripheral portion 511 of the rotary scale 51.

The magnetic sensor 52 is intended to output a signal for measuring the slide distance of the lens group holding frame by using the rotary scale 51 that is rotating. Definitely, the magnetic sensor 52 detects a change of the magnetism from the rotary scale 51 that is rotating, converts the change into a signal, and transmits the signal to outside. The magnetic sensor 52 is provided opposite to the rotary scale 51 in the bottom portion 413 of the holding portion 41. The magnetic sensor 52 is connected to a control section (not shown). The control section is configured to calculate the slide distance of the lens group holding frame on the basis of a signal output from the magnetic sensor 52.

Next, a measuring method of the lens group holding frame by use of the rotary encoder 5 will be described. First, the rotary scale 51 rotates at the same time with the sliding movement of the lens group holding frame. As a result of the rotation, the magnetic pattern of the rotary scale 51 crosses in front of the magnetic sensor 52. At this time, magnetic sensor 52 converts a magnetic change caused by the rotary scale 51 into a signal and transmits the signal to the control section. The control section calculates the amount of rotation of the rotary scale 51 by using the signal output from the magnetic sensor 52, further calculates the slide distance of the lens group holding frame from the amount of rotation, and thereby obtains the slide distance of the lens group.

With the composition, in the drive unit 1 of the present embodiment, the rotary scale 51 is provided at the one-end side of the lead screw 21. For this reason, the drive unit 1 of the present embodiment enables to reduce the housing space of the holding portion 41 compared to a drive unit in which an encoder scale is provided at the driving nut 22 or the connecting part 3. That is, the drive unit 1 of the present embodiment enables to reduce the size of the holding means 4. Accordingly, the drive unit 1 of the present invention can be miniaturized even though it has the function of measuring the slide distance of the lens group holding frame. And with such a construction, the camera module 102 (see FIG. 1) can be miniaturized. Furthermore, being provided with the camera module 102, the cellular phone 101 (see FIG. 1) can be miniaturized.

Incidentally, although in the drive unit 1 of the present embodiment, the driving nut 22 is composed of the nut 23 and the four piezo-elements 24, the composition of the driving nut may not be limited to the composition of the driving nut 22 of the embodiment.

In the drive unit 1 of the present embodiment, each of a pair of the supporting means 42, 42 is composed of the holder 44 and the bearing ball 45. For this reason, the drive unit 1 of the present embodiment enables to rotate the lead screw 21 smoothly with reduced number of components. Accordingly, the drive unit 1 of the present embodiment enables to move the lens group holding frame smoothly with reduced cost.

Furthermore, in the drive unit 1 of the present embodiment, the two plate springs 43 are arranged between the front-side holder 44 and the front portion 411 of the holding portion 41. As a result of this, the front-side holder 44 is driven backward by the spring force of the plate springs 43 and constantly presses the front-side bearing ball 45 against the concave portion 21a of the lead screw 21. With such a construction, the lead screw 21 constantly presses the rear-side bearing ball 45 into the concave portion 443a of the rear-side holder 44.

Therefore, in the drive unit 1 of the present embodiment, both of the bearings 45, 45 have a bigger supporting force of working for a sandwiching and holding method compared to a drive unit which is not provided with the plate spring 43, and hence the drive unit 1 enables to rotate the lead screw 21 more smoothly. Accordingly, in the drive unit 1 of the present embodiment enables to move the lens group holding frame more smoothly.

### Second Embodiment

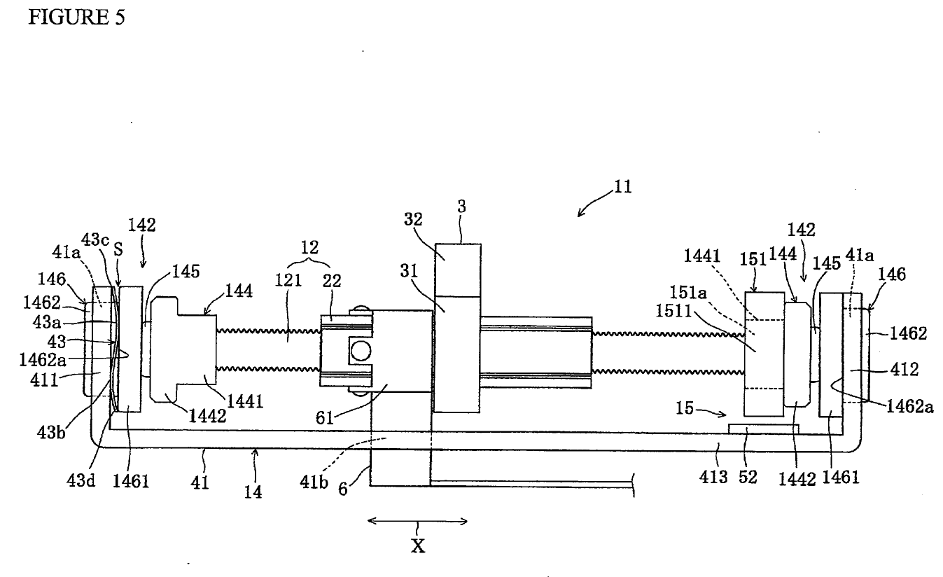

FIG. 5 is a schematic side view of a drive unit 11 in the second embodiment of the present invention. Incidentally, in the embodiment, the same reference numerals refer to the same portions as in the drive unit 1 of the first embodiment, and explanations will be given mainly of different portions. As with the drive unit 1 of the first embodiment, the drive unit 11 of the embodiment is intended for driving a lens group holding frame. The drive unit 11 is provided with a piezo-motor 12, a connecting part 3, holding means 14 and a rotary encoder 15.

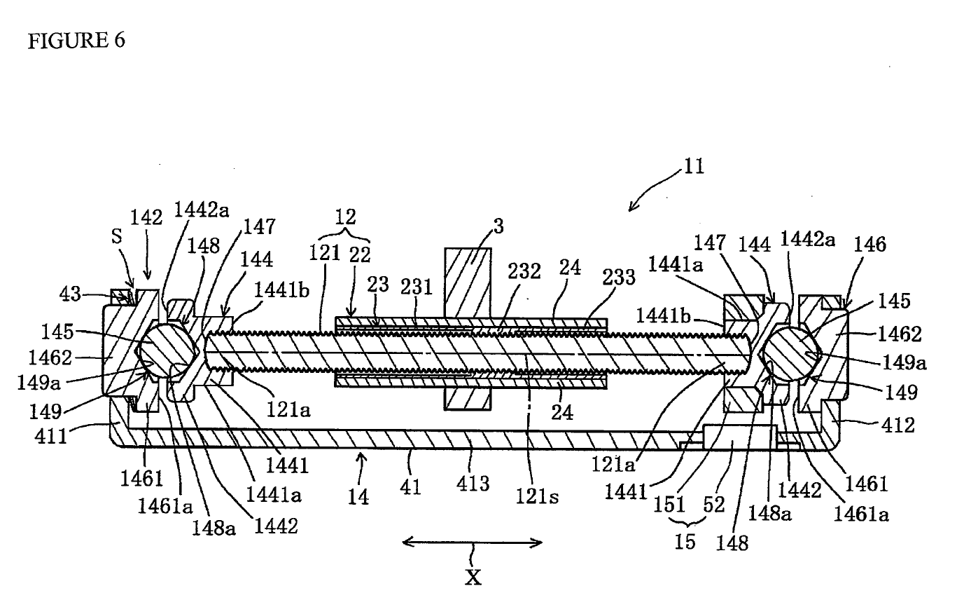

The piezo-motor 12 is provided with a lead screw 121 and a driving nut 22. The lead screw 121 is arranged for the optical axis direction X. And as shown in FIG. 6, the lead screw 121 is not provided with a concave portion at both end surfaces, unlike the lead screw 21 of the first embodiment, but has a general composition.

On the other hand, the holding means 14 is provided with a holding portion 41, a pair of supporting means 142, 142, and two plate springs 43.

The pair of supporting means 142, 142 is to support to be able to rotate in both end sides of the lead screw 121. As shown in FIGS. 5 and 6, each of the supporting means 142 is provided with a lead screw holder 144, a bearing ball 145, and a bearing ball holder 146.

These three portions are arranged on the line for the axial direction (optical axis direction) of the lead screw 121. Definitely, the lead screw holder 144, the bearing ball 145 and the bearing ball holder 146 are arranged in order close to the lead screw 121.

The lead screw holder 144 is formed in the shape of a bolt facing the optical axis direction X. To explain definitely, the lead screw holder 144 is composed of a shaft 1441 formed on the lead screw 21 side and a head formed on the holding portion 41 side. The head is formed to be wider than the shaft 1441. A peripheral portion 1441a of the shaft 1441 is formed in the shape of an annulus around an axis 121s of the lead screw 121.

As shown in FIG. 6, a first concave portion 147 is provided at a surface 1441b facing the lead screw 121 in the shaft 1441. An end portion 121a of the lead screw 121 is held in the first concave portion 147.

A second concave portion 148 is provided at a surface 1442a facing the holding portion 41 in the shaft 1442. A bottom surface 148a of the second concave portion 148 is formed such that the sectional shape thereof has a wedge-shaped dent for the optical axis direction X.

On the other hand, the bearing ball holder 146 is composed of a holder main frame 1461 and a mounting portion 1462. The mounting portion 1462 is mounted by being inserted onto a holder method 41a of the holding portion 41, and formed in square shape. The mounting portion 1462 may be circular.

The holder main frame 1461 is arranged within the holder portion 41 and connected to an inner end surface 1462a of the mounting portion 1462 (see FIG. 5). The holder main frame 1461 has vertical and lateral dimensions larger than the mounting portion 1462 and is formed in square shape. The holder main frame 1461 may be circular.

As shown in FIG. 6, a third concave portion 149 is provided at an inner end surface 1461a of the holder main frame 1461. The third concave portion 149 is opposed to the second concave portion 148. A bottom surface 149a of the third concave portion 149 is formed such that the sectional shape thereof has a wedge-shaped dent for the optical axis direction X.

The bearing ball 145 is sandwiched and held between the second concave portion 148 of the lead screw holder 144 and the third concave portion 149 of the bearing ball holder 146.

As shown in FIG. 5, the two plate springs 43 are each arranged between two gaps formed in the shape of letter S between the front portion 411 of the holding portion 41 and the holder main frame 1461 on the right and left sides of the mounting portion 1462. And a curved portion 43a on the upper side of the plate spring 43 touch to the holder main frame 1461, and a curved portion 43b on the lower side touch to the front portion 411 of the holding portion 41. And, a top end portion 43c of the plate spring 43 is fixed to the front portion 411 of the holding portion 41. In this state, a bottom end portion 43d thereof is fixed to the holder main frame 1461.

Next, a driving method of the lens group holding frame by using the drive unit 11 will be described below. First, a drive power supply and a control signal are supplied from the power supply and the control section to each of the piezo-elements 24 via the flexible printed wiring board 6. With such a construction, each of the piezo-elements 24 vibrates and the lead screw 21 rotates clockwise or counterclockwise. Through the rotation of the lead screw 21, the lead screw holder 144 rotates and the nut 23 moves on the lead screw 21. As a result of the movement, the connecting part 3 moves for the optical axis direction X and the lens group holding frame slides along the guide pole in the optical axis direction X.

On the other hand, the rotary encoder 15 is used for measuring the slide distance of the lens group holding frame (lens group). The rotary encoder 15 is a magnetic type rotary encoder. And the rotary encoder 15 is composed of a rotary scale 151 and a magnetic sensor (detection means) 52.

The rotary scale 151 is formed in the shape of a ring. And the rotary scale 151 is provided at a one-end side of the lead screw 21. To explain definitely, the rotary scale 151 is fixed such that a center hole 151a (see FIG. 5) thereof is fixed by being fit onto the peripheral portion 1441a of the shaft of the lead screw holder 144. A prescribed magnetic pattern is circumferentially formed in a peripheral portion 1511 of the rotary scale 151.

Next, a measuring method of the lens group holding frame by use of the rotary encoder 15 will be described. First, the rotary scale 151 rotates at the same time with the sliding movement of the lens group holding frame. As a result of the rotation, the magnetic pattern of the rotary scale 151 crosses in front of the magnetic sensor 52. At this time, magnetic sensor 52 converts a magnetic change caused by the rotary scale 151 into a signal and transmits the signal to the control section. The control section calculates the amount of rotation of the rotary scale 151 by using the signal output from the magnetic sensor 52, further calculates the slide distance of the lens group holding frame from the amount of rotation, and thereby obtains the slide distance of the lens group.

With the construction, in the drive unit 11 of the present embodiment, the rotary scale 151 is provided at the one-end side of the lead screw 121. Therefore, the drive unit 11 of the present embodiment enables to reduce the housing space of the holding portion 41 compared to a drive unit in which an encoder scale is provided at the driving nut 22 or the connecting part 3. Therefore, the drive unit 11 of the present embodiment enables to reduce the size of the holding means 14. Accordingly, the drive unit 11 of the present embodiment can be miniaturized even having the function of measuring the slide distance of the lens group holding frame. With such a construction, a camera module and a cellular phone provided with the drive unit 11 can be miniaturized.

In the drive unit 11 of the present embodiment, each of a pair of the supporting means 142, 142 is composed of two holders 144, 146 and a bearing ball 145. As a result of this, the drive unit 11 of the present embodiment enables to freely set the size of the concave portions 148, 149 to sandwich and hold the bearing ball 145 without consideration on the diameter of the lead screw 121

For this reason, the drive unit 11 of the present embodiment enables to use a larger bearing ball 145 compared to the drive unit 1 in which the bearing ball 45 is sandwiched and held between the lead screw 21 and the holder 44, as described in the first embodiment. Therefore, the drive unit 11 of the present embodiment enables the lead screw supported to be able to rotate more stable. Accordingly, the drive unit 11 of the present embodiment enables to move the lens group holding frame more smoothly.

Furthermore, in the drive unit 11 of the present embodiment, the two plate springs 43 are arranged between the front-side bearing ball holder 146 and the front portion 411 of the holding portion 41. With such a construction, the front-side bearing ball holder 146 is driven backward by the spring force of the plate springs 43 and constantly presses the front-side bearing ball 145 against the lead screw holder 144. With such a construction, the lead screw 121 constantly presses the rear-side bearing ball 145 against the rear-side bearing ball holder 146 via the rear-side bearing ball holder 146.

Therefore, in the drive unit 11 of the present embodiment, both of the bearings 145, 145 have a bigger supporting force working for a sandwiching and holding method compared to a drive unit without the plate spring 43, and hence the drive unit 11 enables to rotate the lead screw 121 more smoothly. Accordingly, in the drive unit 11 of the present embodiment enables to move the lens group holding frame more smoothly.

Furthermore, in the drive unit 11 of the present embodiment, the rotary scale 151 is to fit onto the lead screw holder 144. With such a construction, the drive unit 11 of the present invention makes it possible to install the rotary scale 151 and the lead screw holder 144 to one-end side of the lead screw 121 in construction of the drive unit, or detach them in separation of the lead screw as one unit. Accordingly, the drive unit 11 of the present embodiment enables to improve the efficiency of assembling or disassembling the drive unit.

Incidentally, in this embodiment, by fitting the rotary scale 151 onto the lead screw holder 144, the rotary scale 151 is inserted on the one-end side of the lead screw 121 and fixed to the lead screw 121 indirectly. However, the method of attaching the rotary scale 151 is not limited to this, but the rotary scale 151 may be inserted in the one-end side of the lead screw 121 and fixed directly to the lead screw 121.

Incidentally, although, a magnetic type rotary encoder is used in the embodiment of the drive unit described above, a rotary encoder of other schemes may also be used. And the rotary scale and the detection means are to be composed according to the kind of the rotary encoder to be used.

Although in the embodiments, the descriptions are given of the case where the present invention is used in a cellular phone, the present invention may also be used in other imaging devices such as digital cameras. In particular, the drive unit of the present invention is suitable for use in an imaging device for which the installation space of a lens driving unit is limited. It is not always required that the drive unit described in the embodiments be limited for moving the lens group holding frame. The drive unit described in the invention may also be used in moving other driven objects.

### INDUSTRIAL APPLICABILITY

As described above, the drive unit of the present invention can be miniaturized even though the drive unit has the function of measuring the slide distance of driven object. Therefore, the present invention can be used in the technical field of a small drive unit having the function of measuring the slide distance of driven object.

What is claimed is:

1. A drive unit to slide a driven object,
comprising:
a lead screw;
a driving nut screwed onto a central part of the lead screw;
a connecting part protruding from the driving nut for being connected to the driven object;
a rotary scale inserted onto a one-end side of the lead screw and fixed directly or indirectly;
a holding means containing the lead screw supported to be able to rotate, to which the rotary scale and the driving nut are attached; and
a detection means provided at the holding means,
wherein the driving nut rotates the lead screw clockwise or counterclockwise by a driving power and a control signal from outside, thereby moving on the lead screw;
the connecting part makes the driven object slide by utilizing the movement of the driving unit;
the rotary scale rotates as a result of the rotation of the lead screw; and
the detection means transmits output signal measuring the slide distance of the driven object by using the rotary scale rotating together with lead screw to outside.

2. The drive unit according to claim 1,
wherein the driving nut is provided with a nut screwed onto a central part of the lead screw and a piezo-element provided at a peripheral portion of the nut, the connecting part being connected to the piezo-element; a driving power and a control signal are supplied to the piezo-element to move the nut on the lead screw by rotating the lead screw clockwise or counterclockwise; and
the connecting part is provided to slide the driven object by utilizing the movement of the nut.

3. The drive unit according to claim 1, wherein a concave portion is provided at both end surfaces of the lead screw, the holding means having a pair of supporting means for supporting to be able to rotate in both end sides of the lead screw; and
each of the pair of supporting means comprises a holder having a concave portion opposed to the concave portion of the lead screw and a bearing ball sandwiched and held between the concaved portion of the holder and the concaved portion of the lead screw.

4. The drive unit according to claim 1,
wherein the holding means has a pair of supporting means for supporting to be able to rotate both end sides of the lead screw,
each of the pair of supporting means comprising a lead screw holder, a bearing ball and a baring ball holder, each of which is arranged close to the lead screw in order along the axis of the lead screw;
the lead screw holder has a first concave portion holding an end portion of the lead screw and a second concave portion provided at a side opposite to the first concave portion, and the lead screw holder rotates as a result of the rotating of the lead screw;
the bearing ball holder has a third concave portion opposed to the second concave portion of the lead screw holder; and
the bearing ball is sandwiched and held between the second concave portion of the lead screw holder and the third concave portion of the bearing ball holder.

5. The drive unit according to claim 4,
wherein the lead screw holder of one of the pair of supporting means is such that a peripheral portion of a first concave portion is formed in the shape of an annulus as a center of the axis of lead screw and the rotary scale is to be fit onto the peripheral portion.
